(19) United States
(12) Patent Application Publication
(10) Pub. No.: US 2019/0034342 A1
(43) Pub. Date: Jan. 31, 2019

(54) CACHE DESIGN TECHNIQUE BASED ON ACCESS DISTANCE

(71) Applicant: QUALCOMM Incorporated, San Diego, CA (US)

(72) Inventor: Kai MA, Apex, NC (US)

(21) Appl. No.: 15/663,676

(22) Filed: Jul. 28, 2017

(51) Int. Cl. G06F 12/0864; G06F 1/32; G06F 12/128; G06F 12/123

(52) U.S. Cl. CPC G06F 12/0864; G06F 1/3275; G06F 2212/621; G06F 12/123; G06F 2212/6032; G06F 12/128

(57) ABSTRACT

Techniques for cache design comprise determining, for one or more sets of a set associative cache, a number of access distance instances encountered in a memory trace for one or more ways within each of the one or more sets, wherein an access distance instance for a way corresponds to a number of unique accesses to other ways which occur between two accesses for the same way. Access distance vectors are formed for each of the one or more sets, wherein elements of the access distance vector for a set comprise the number of access distance instances for each of the one or more ways of the set. At least a subset of the one or more sets and at least a subset of the one or more ways are identified, to be included in the cache, based on the values of the elements of the access distance vectors.

### FIELD OF DISCLOSURE

Disclosed aspects are directed to cache memories in processing systems. More specifically, exemplary aspects are directed to efficient techniques for designing caches.

### BACKGROUND

A processing system may comprise one or more processors which can make requests for accessing data stored in a memory. Memory requests generated by a processor may display temporal locality, which means that the requests are directed to data which was recently requested, and correspondingly also means that the same data may be requested again in the near future. To exploit temporal locality, one or more caches may be provided to store data which is determined to have likelihood of future use.

The caches may generally be designed to be small in size to enable high speeds. However, numerous parameters and configurations may be adjusted to tailor cache designs for particular needs. For instance, some applications may benefit from different organizations of cache lines such as a direct mapped cache, fully associative, or set associative as known in the art. Furthermore, various choices may exist in the design space, even within particular organizations. For example, in set associative cache designs, varying the number of sets and/or the number of ways within each set can cause significant deviations in the performance (e.g., in terms of the number of cache hits) of the caches for different applications.

Conventional cache design techniques employ simulation mechanisms to explore the performance of different cache configurations for different workloads or applications. However, such simulations may be very intensive because they seek to simulate various options (e.g., in terms of cache size, associativity, configuration, etc.) for several workloads, and then make a determination regarding the specific options to be selected for a desired workload. Furthermore, conventional manners of storing and using the large numbers of simulation results also tend to be inefficient, which makes selection of the desired options difficult.

Accordingly, a need is recognized for improving the efficiency of processes involved in designing caches.

### SUMMARY

Exemplary aspects of the invention are directed to cache design techniques. An example method comprises determining, for one or more sets of a set associative cache, a number of access distance instances encountered in a memory trace for one or more ways within each of the one or more sets, wherein an access distance instance for a way corresponds to a number of unique accesses to other ways which occur between two accesses for the same way. An access distance vector is formed for each of the one or more sets, wherein elements of the access distance vector for a set belonging to the one or more sets comprise the number of access distance instances for each of the one or more ways of the set. At least a subset of the one or more sets and at least a subset of the one or more ways to be included in a cache design of the set associative cache are identified, based on the values of the elements of one or more access distance vectors of one or more sets.

Another exemplary aspect is directed to a non-transitory computer-readable storage medium comprising code, which, when executed by a processor, causes the processor to perform a method of cache design. The non-transitory computer-readable storage medium comprises code for determining, for one or more sets of a set associative cache, a number of access distance instances encountered in a memory trace for one or more ways within each of the one or more sets, wherein an access distance instance for a way corresponds to a number of unique accesses to other ways which occur between two accesses for the same way; code for forming an access distance vector for each of the one or more sets, wherein elements of the access distance vector for a set belonging to the one or more sets comprise the number of access distance instances for each of the one or more ways of the set; and code for identifying at least a subset of the one or more sets and at least a subset of the one or more ways to be included in a cache design of the set associative cache, based on the values of the elements of one or more access distance vectors of one or more sets.

Another exemplary aspect is directed to an apparatus comprising a cache, wherein the cache is a set associative cache designed with at least a subset of one or more sets and at least a subset of one or more ways. The subset of the one or more sets and the subset of the one or more ways are identified based on values of elements of one or more access distance vectors associated with the one or more sets, wherein the access distance vectors are determined based on: for the one or more sets, a number of access distance instances encountered in a memory trace for one or more ways within each of the one or more sets, wherein an access distance instance for a way corresponds to a number of unique accesses to other ways which occur between two accesses for the same way. Elements of the access distance vector for a set belonging to the one or more sets comprise the number of access distance instances for each of the one or more ways of the set.

Yet another exemplary aspect is directed to a method of cache design comprising: step for determining, for one or more sets of a set associative cache, a number of access distance instances encountered in a memory trace for one or more ways within each of the one or more sets, wherein an access distance instance for a way corresponds to a number of unique accesses to other ways which occur between two accesses for the same way; step for forming an access distance vector for each of the one or more sets, wherein elements of the access distance vector for a set belonging to the one or more sets comprise the number of access distance instances for each of the one or more ways of the set; and step for identifying at least a subset of the one or more sets and at least a subset of the one or more ways to be included in a cache design of the set associative cache, based on the values of the elements of one or more access distance vectors of one or more sets.

### BRIEF DESCRIPTION OF THE DRAWINGS

The accompanying drawings are presented to aid in the description of aspects of the invention and are provided solely for illustration of the aspects and not limitation thereof.

FIG. 1 depicts an exemplary processing system according to aspects of this disclosure.

FIGS. 2A-B illustrate aspects of determining access distances and forming access distance vectors, according to aspects of this disclosure.

FIG. 3 depicts an exemplary method for cache design according to aspects of this disclosure.

FIG. 4 depicts an exemplary computing device in which an aspect of the disclosure may be advantageously employed.

### DETAILED DESCRIPTION

Aspects of the invention are disclosed in the following description and related drawings directed to specific aspects of the invention. Alternate aspects may be devised without departing from the scope of the invention. Additionally, well-known elements of the invention will not be described in detail or will be omitted so as not to obscure the relevant details of the invention.

The word “exemplary” is used herein to mean “serving as an example, instance, or illustration.” Any aspect described herein as “exemplary” is not necessarily to be construed as preferred or advantageous over other aspects. Likewise, the term “aspects of the invention” does not require that all aspects of the invention include the discussed feature, advantage or mode of operation.

The terminology used herein is for the purpose of describing particular aspects only and is not intended to be limiting of aspects of the invention. As used herein, the singular forms “a,” “an,” and “the” are intended to include the plural forms as well, unless the context clearly indicates otherwise. It will be further understood that the terms “comprises”, “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

Further, many aspects are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects of the invention may be embodied in a number of different forms, all of which have been contemplated to be within the scope of the claimed subject matter. In addition, for each of the aspects described herein, the corresponding form of any such aspects may be described herein as, for example, “logic configured to” perform the described action.

Aspects of this disclosure are directed to exemplary techniques for organizing and using parameters of cache designs which enable an efficient selection of cache configurations. More specifically, simulation intensity associated with the process of designing caches is reduced using an exemplary method of tabulation of cache results. In the following passages, designing a set associative cache will be described according to exemplary aspects (it is recognized that a set associative design offers the most flexible design space in comparison to other options such as direct mapped or fully associative, and so the set associative design is considered in more detail in this disclosure).

As will be described in further detail with reference to the figures, an access distance (AD), as known in the art is used as a criterion for selecting the desirable number of ways and sets for the design of a set associative cache. An access distance is generally defined as the number of unique accesses that occur between two accesses to the same address or cache line in a cache for a particular program code or workload. In an aspect, access distances for one or more ways of each set of the cache are determined. Access distance vectors are then created for two or more sets and tabulated as will be explained further below. The exemplary tabulation enables an efficient selection of the sets and a number of ways accessed by the program code which would result in the desired performance. In some aspects, power savings features may also be explored from the access distance stack, by disabling or not selecting portions (e.g., sets or ways) which do not provide a desired performance, to conserve power, accordingly.

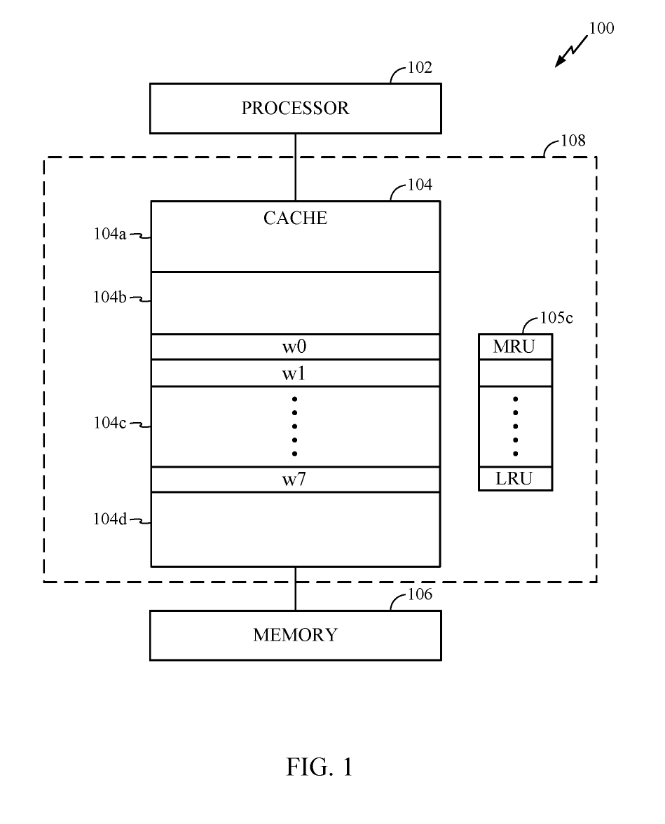

With reference to FIG. 1, exemplary processing system 100 is illustrated with processor 102, cache 104, and memory 106 representatively shown, keeping in mind that various other components which may be present have not been illustrated for the sake of clarity. Processor 102 may be any processing element configured to make memory access requests to memory 106 which may be a main memory. Cache 104 may be one of several caches present in between processor 102 and memory 106 is a memory hierarchy of processing system 100.

As shown, cache 104 may be a set associative cache with four sets 104a-d shown for the sake of an example illustration. The management of the replacement policies for cache 104 may be implemented by any suitable combination of hardware and software, for example by cache controller 108 (schematically shown with dashed lines around cache 104) or other similar mechanisms known the art. Each set 104a-d of cache 104 may have multiple ways of cache lines. Eight ways w0-w7 of cache lines for set 104c have been representatively illustrated in the example of FIG. 1.

Replacement policies such as a least recently used (LRU) policy may involve selection of at least one way of ways w0-w7 to be evicted and replaced in set 104c with an incoming cache line if there is a miss and the incoming cache line is not present in cache 104 (but if the incoming cache line is present, then it is not evicted). An objective of a replacement policy such as LRU is to populate cache 104 with the most recently used cache lines, and more specifically, based on the most recently used unique accesses. The least recently used or most recently used cache accesses may be estimated by recording an order of the cache lines in ways w0-w7 from most recently accessed or most recently used (MRU) to least recently accessed or least recently used (LRU) in stack 105c, which is also referred to as an LRU stack. LRU Stack 105c may be a buffer or an ordered collection of registers, for example, wherein each entry of LRU stack 105c may include an indication of a way, ranging from MRU to LRU (e.g., each entry of stack 105c may include 3-bits to point to one of the eight ways w0-w7, such that the MRU entry may point to a first way, e.g., w5, while the LRU entry may point to a second way, e.g., w3, in an illustrative example).

In the implementation of exemplary aspects, an access distance may be calculated by studying the number of unique accesses that occur between two accesses to the same address or cache line. For instance, an access distance pertaining to way w0 may be calculated by studying the number of different or unique accesses to any of the other ways w1-w7 which may be interspersed between two accesses to way w0. For instance, considering an illustrative sequence of accesses to ways [w0,w2,w1,w1,w0], the access distance for way w0 is seen to be 3 (with the count starting at the first access to way w0 and counting three more unique accesses to ways w2, w1, w1, accessed before the next access to way w0); similarly, the access distance for way w1 is 1.

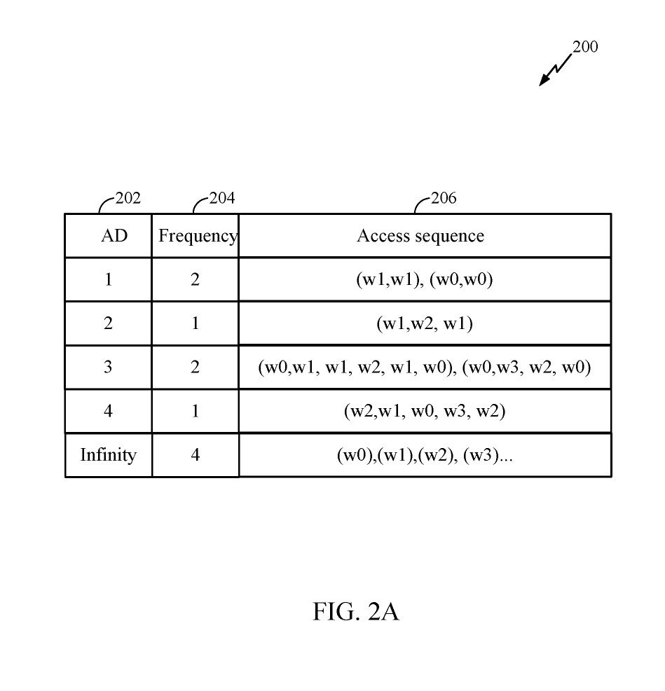

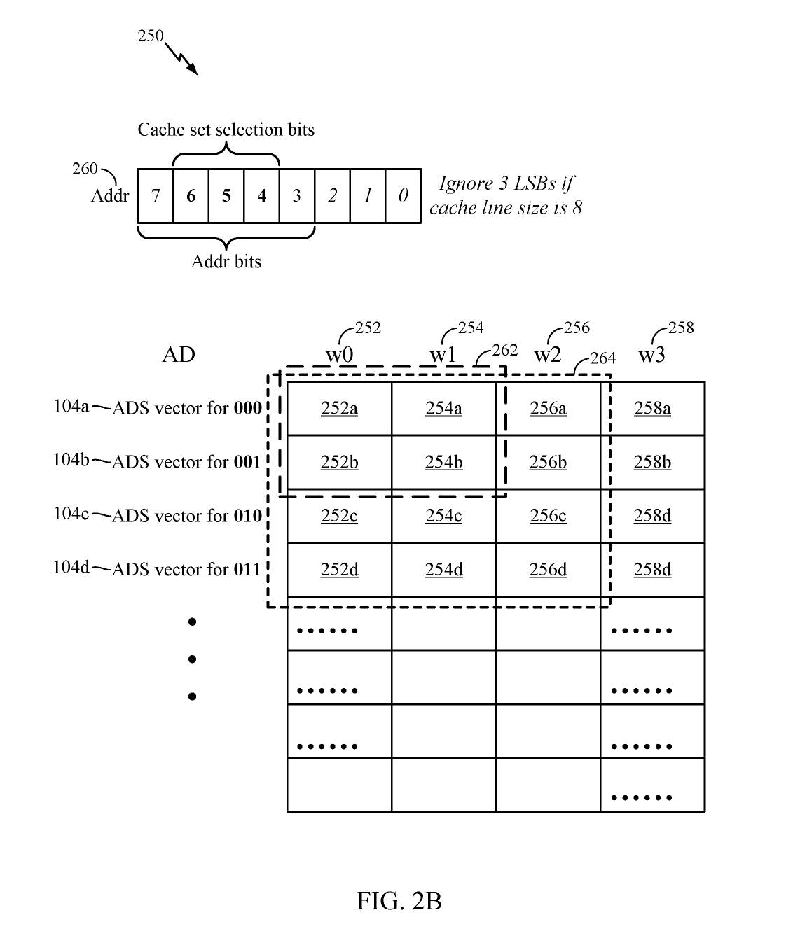

In the illustrative table 200 shown in FIG. 2A, more examples for calculating access distances for different sequences of accesses (e.g., based on accesses to ways w0-w7 of set 104c of FIG. 1 for an illustrative program code or memory trace thereof) are shown. The access distance (“AD”, also referred to as a “key” in some instances) is shown in column 202. Column 204 shows a corresponding number of instances that the AD in column 202 is encountered in an example access sequence or memory trace shown in column 206. Generating an access distance stack using the number of instances for each access distance, for each set 104a-d of cache 104, will now be explained with reference to FIG. 2B.

Turning to FIG. 2B, an exemplary table or stack, identified as access distance stack 250 is shown. It is observed that within each set 104a-d of cache 104, for example, the cache lines within the various ways are fully associative, in the sense that if the address of a particular cache line indexes to one of the sets 104a-d, then that cache line may go in any one of the available ways w0-w7 of that set. The specific way that the cache line would go into would be based on the replacement policies if an existing cache line (victim cache line) in that set is to be evicted to make room for the incoming cache line. Although not shown, each cache line also has an associated tag which may be placed in a tag array and may contain a portion of the address of that cache line. Whether there is a hit in one of the ways w0-w7 is determined based on a tag comparison among the ways w0-w7 to determine which way has a hit.

If an empty cache set is being populated, it can be assumed without loss of generality that a first access (e.g., write of a cache line) may be directed to way w0, a second access to way w1, and so on until all ways w0-w7 in the illustrated example of FIG. 1 are populated. Studying the access distance instances for each one of ways w0-w7 provides an indication of the usefulness of having the respective way in a particular set of the cache. Viewed differently, if it is observed that way w0 is accessed more frequently (or has more instances in a code sequence) than way w1, then way w0 may be considered more useful than way 1. If a decision is to be made regarding how many ways are to be included in a particular cache design for a set, then a threshold value of the number of access distance instances may be specified such that ways which have a greater number of access distance instances than the threshold may be chosen, while ways which have less than the threshold may be left out. Access distance stack 250 provides an efficient way to make determinations such as these.

Considering FIG. 2B in more detail, an example cache address 260 is shown with 8 bits, of which bits [6:4] are used to select between one of the sets 104a-d of cache 104, disposed in a column direction, as shown. For each set 104a-d, an access distance vector is calculated, with each element of the vector comprising access distance instances for the respective ways that exist within the set. In more detail, the columns 252, 254, 256, and 258 each comprise the various ways, disposed in a row direction, e.g., ways w0, w1, w2, w3, respectively. Correspondingly, the elements of the access distance vector for each set are access distance instances for the different ways of the set. For example, the elements of the access distance vector for set 104a are 252a, 254a, 256a, and 258a, which respectively indicate the access distance instances for ways w0, w1, w2, and w3 of set 104a. Viewed another way, in access distance stack 250, elements 252a-d are shown for sets 104a-d in column 252 corresponding to way w0 of each one of sets 104a-d, respectively; elements 254a-d are shown for sets 104a-d in column 254 corresponding to way w1 of each one of sets 104a-d, respectively; elements 256a-d are shown for sets 104a-d in column 256 corresponding to way w2 of each one of sets 104a-d, respectively; and elements 258a-d are shown for sets 104a-d in column 258 corresponding to way w3 of each one of sets 104a-d, respectively. Based on the access distance instances or values of each of these elements 252a-d, 254a-d, 256a-d, 258a-d, etc., of access distance stack 250, decisions may be made whether to include these elements (and corresponding sets/ways) in a particular design of cache 104. For instance, design techniques described herein may comprise selecting sets and ways having elements which meet specified threshold values to be included in the cache design of cache 104, as will be further described in the following sections.

An illustrative example will now be provided by way of explanation for generating the above-noted elements 252a-d, 254a-d, 256a-d, 258a-d, etc., of access distance stack 250. A memory trace or memory addresses visited (expressed in hexadecimal values) may include the following sequence of accesses in one illustrative example: 00, 14, 04, 38, 34, 04, 18, 80, 24, 08, 00, 30, 18, 88, 28, and 80. From the above sequence, bits [6:4] of cache address 260 may exemplarily map these access addresses (or at least a subset of bits of these access addresses of the memory trace) to one or more of sets 104a-d as follows: set 104a for which bits [6:4] of cache address 260 are considered to be “000” in an example may include the subset of accesses {00, 04, 04, 80, 08, 00, 88, 80}; set 104b for which bits [6:4] of cache address 260 are considered to be “001” may include the subset of accesses {14, 18, 18}; set 104c for which bits [6:4] of cache address 260 are considered to be “010” may include the subset of accesses {24, 28}; and set 104d for which bits [6:4] of cache address 260 are considered to be “011” may include the subset of accesses {38, 34, 30}.

For each one of sets 104a-d, the respective access distance vector may be generated by considering the access sequences for that set. Considering the subset of accesses to set 104a {00, 04, 04, 80, 08, 00, 88, 80} in more detail, this is seen to include one sequence of accesses with an access distance of 1 (i.e., the sequential accesses {04, 04}), which means that an access to an address is immediately after a previous access to the same address. In this case, if set 104a is designed with just one way (e.g., way w0), then by holding the previous access in that way without being replaced, the subsequent access would result in a hit. The number of similar instances with such an access distance of 1 for set 104a (corresponding to a single way, w0) is aggregated as more accesses are traced in an example simulation, and captured as element 252a.

Continuing with the above example involving the subset of accesses to set 104a {00, 04, 04, 80, 08, 00, 88, 80} there is similarly seen to be one sequence with an access distance of 2, one sequence with an access distance of 3, one sequence with an access distance of 4, none or zero sequences with an access distance of 5 or greater, as well as four instances which are first time visits an address without a repeated access to the same address. Each of these are respectively captured in the remaining elements of the access distance vector for set 104a (i.e., the access distance of 2 in element 254a for way w1, the access distance of 3 in element 256a for way w2, the access distance of 4 in element 258a for way w3, etc.). Considering in detail the access distance of 4 as yet another example, the subset of accesses {80, 08, 00, 88, 80} for way w3 (captured in element 258a) means that if set 104a were designed with four ways, then the first visit to address “80” and the subsequent three unique memory accesses in between {08, 00, 88} may be stored in four ways, such that the next or second visit to address “80” would result in a cache hit. In other words, by capturing the number of instances of access distance of 4 in element 258a, an indication is provided as to the number of cache hits that may be generated if set 104a were to be designed with four ways.

Although not explained in further detail, similar access distance vectors may be created for the remaining sets 104b-d based on subsets of accesses to these sets based on bits [6:4] of cache address 260 by studying example accesses or memory traces. Once tabulated in this manner, the elements of these access distance vectors in access distance stack 250 may be chosen, possibly in combination, to create a desired configuration of cache 104.

For instance, by analyzing the access distance vectors for a particular memory trace, it may be determined that the number of instances recorded in elements 252a-b and 254a-b cross a desired threshold, or in some cases, in combination, may generate a number of cache hits which would meet performance considerations. In such a case, a decision may be made to choose a 2-set, 2-way cache design, identified in FIG. 2B as combination 262 comprising sets 104a-b, each with two ways, w0-w1. In an exemplary aspect, a flexible cache design configuration which may support more sets and/or ways, remaining sets and/or ways outside this combination 262 may be powered down or powered off if they are not selected to be included in a particular cache design (e.g., corresponding logic such as clock gating logic may be provided in cache controller 108 to power down or turn off power to sets and/or ways outside combination 262). In similar manner, various other combinations of sets and ways may be possible (with corresponding logic configured to turn off or power down ways and/or sets outside the selected combinations). Combination 264 comprising all of the illustrated four sets 104a-d and three ways w0-w2 is shown as another exemplary design option, and may be based on elements 252a-d, 254a-d, and 256a-d all meeting respective threshold value considerations.

Accordingly, access distance stack 250 may be used to efficiently convey information regarding which sets and/or ways, if included in a cache design for cache 104 would performance expectations (e.g., number of hits) for a program code or memory trace under consideration

As can be appreciated, the above exemplary processes for selecting cache configurations, e.g., desired number of sets and/or ways is straightforward and reduces simulation time in comparison to simulating cache 104 for each workload with each one of the various options, e.g., each combination of possible sets and ways available in a design space.

Moreover, the above aspects may also be extended to other memory structures such as queues, buffers, etc. (e.g., as may be used in components of processors such as memory controllers or interface units, not explicitly shown). For instance in determining an optimum or desirable queue or buffer sizes for each workload under consideration, the number of access distance instances may be similarly calculated and based on the access distance frequencies for each entry, the number of entries, and hence the size of the queue or buffer may be efficiently determined.

In yet other aspects, cache configurations may also be selected by considering the miss counts or number of cache misses, in addition to or in lieu of the access distance frequencies. For instance, in a table such as access distance stack 250 of FIG. 2A, miss counts for each set and way under consideration may be simulated and flexible caches may be designed based on performance considerations in terms of the number of misses which may be tolerable for the various design options. In one possible scenario for the sake of illustration of the above concepts, it may be determined that a smaller cache with groups of sets which experience low miss counts may be used for a workload, without involving sets or groups of sets which see more misses and thus may not be contributing well to performance of the cache.

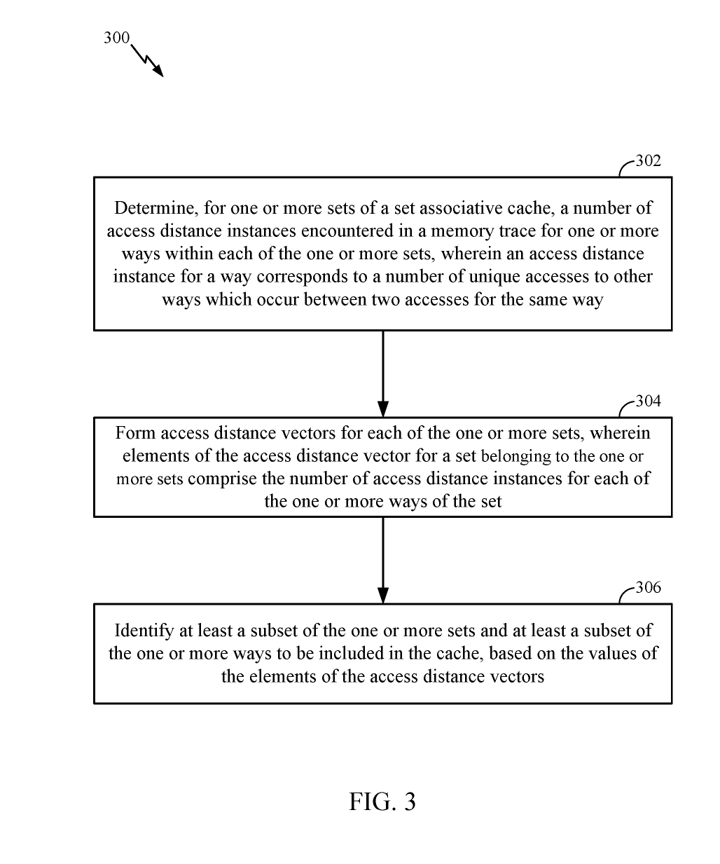

Accordingly, it will be appreciated that exemplary aspects include various methods for performing the processes, functions and/or algorithms disclosed herein. For example, FIG. 3 illustrates a method 300 of cache design.

In Block 302, method 300 comprises: determining, for one or more sets (e.g., sets 104a-d) of a set associative cache (e.g., cache 104), a number of access distance instances encountered in a memory trace for one or more ways within each of the one or more sets, wherein an access distance instance for a way corresponds to a number of unique accesses to other ways which occur between two accesses for the same way (e.g., as explained with reference to FIG. 2A).

In Block 304 method 300 comprises forming an access distance vector for each of the one or more sets, wherein elements of the access distance vector for a set belonging to the one or more sets comprise the number of access distance instances for each of the one or more ways of the set (e.g., as shown in FIG. 2B).

In Block 306 method 300 comprises identifying at least a subset of the one or more sets and at least a subset of the one or more ways to be included in a cache design of the set associative cache, based on the values of the elements of the access distance vectors of one or more sets (e.g., choosing one of combinations 262 or 264 in the example of FIG. 2B as described above).

It will be understood that exemplary aspects are also directed to an apparatus comprising a cache (e.g., a set associative cache such as cache 104) designed according to method 300. For instance, an exemplary apparatus includes a cache (e.g., cache 104), wherein the cache is a set associative cache designed with at least a subset of one or more sets and at least a subset of one or more ways, wherein the subset of the one or more sets and the subset of the one or more ways are identified based on values of elements of one or more access distance vectors associated with the one or more sets (e.g., based on choosing one of combinations 262 or 264 in the example of FIG. 2B as described above). In the example cache, the access distance vectors may be determined based on, for the one or more sets, a number of access distance instances encountered in a memory trace for one or more ways within each of the one or more sets, wherein an access distance instance for a way corresponds to a number of unique accesses to other ways which occur between two accesses for the same way (e.g., as shown in FIG. 2A). Elements of the access distance vector for a set belonging to the one or more sets comprise the number of access distance instances for each of the one or more ways of the set (e.g., as shown in FIG. 2B).

Furthermore, it will also be understood that exemplary aspects of this disclosure are directed to means and/or step for performing the functions discussed with reference to method 300 of FIG. 3.

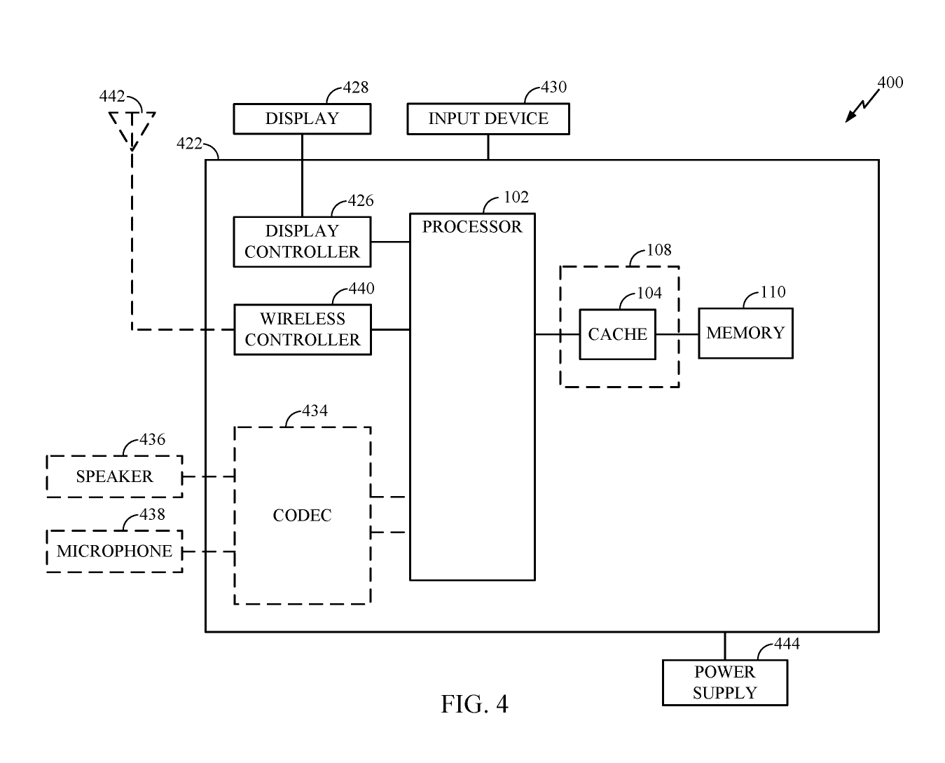

An example apparatus in which exemplary aspects of this disclosure may be utilized, will now be discussed in relation to FIG. 4. FIG. 4 shows a block diagram of computing device 400. Computing device 400 may correspond to an exemplary implementation of a processing system configured to perform method 300 of FIG. 3. In the depiction of FIG. 4, computing device 400 is shown to include processor 102 and cache 104 shown in FIG. 1A, wherein cache 104 is designed according to the techniques described herein. In FIG. 4, processor 102 is exemplarily shown to be coupled to memory 106 with cache 104 between processor 102 and memory 106 as described with reference to FIG. 1, but it will be understood that other memory configurations known in the art may also be supported by computing device 400.

FIG. 4 also shows display controller 426 that is coupled to processor 102 and to display 428. In some cases, computing device 400 may be used for wireless communication and FIG. 4 also shows optional blocks in dashed lines, such as coder/decoder (CODEC) 434 (e.g., an audio and/or voice CODEC) coupled to processor 102 and speaker 436 and microphone 438 can be coupled to CODEC 434; and wireless antenna 442 coupled to wireless controller 440 which is coupled to processor 102. Where one or more of these optional blocks are present, in a particular aspect, processor 102, display controller 426, memory 106, and wireless controller 440 are included in a system-in-package or system-on-chip device 422.

Accordingly, a particular aspect, input device 430 and power supply 444 are coupled to the system-on-chip device 422. Moreover, in a particular aspect, as illustrated in FIG. 4, where one or more optional blocks are present, display 428, input device 430, speaker 436, microphone 438, wireless antenna 442, and power supply 444 are external to the system-on-chip device 422. However, each of display 428, input device 430, speaker 436, microphone 438, wireless antenna 442, and power supply 444 can be coupled to a component of the system-on-chip device 422, such as an interface or a controller.

It should be noted that although FIG. 4 generally depicts a computing device, processor 102 and memory 106, may also be integrated into a set top box, a music player, a video player, an entertainment unit, a navigation device, a personal digital assistant (PDA), a fixed location data unit, a server, a computer, a laptop, a tablet, a communications device, a mobile phone, or other similar devices.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The methods, sequences and/or algorithms described in connection with the aspects disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor.

Accordingly, an aspect of the invention can include a computer readable media embodying a method for cache design. Accordingly, the invention is not limited to illustrated examples and any means for performing the functionality described herein are included in aspects of the invention.

While the foregoing disclosure shows illustrative aspects of the invention, it should be noted that various changes and modifications could be made herein without departing from the scope of the invention as defined by the appended claims. The functions, steps and/or actions of the method claims in accordance with the aspects of the invention described herein need not be performed in any particular order. Furthermore, although elements of the invention may be described or claimed in the singular, the plural is contemplated unless limitation to the singular is explicitly stated.

What is claimed is:

1. A method of cache design comprising:
determining, for one or more sets of a set associative cache, a number of access distance instances encountered in a memory trace for one or more ways within each of the one or more sets, wherein an access distance instance for a way corresponds to a number of unique accesses to other ways which occur between two accesses for the same way;
forming an access distance vector for each of the one or more sets, wherein elements of the access distance vector for a set belonging to the one or more sets comprise the number of access distance instances for each of the one or more ways of the set; and
identifying at least a subset of the one or more sets and at least a subset of the one or more ways to be included in a cache design of the set associative cache, based on the values of the elements of one or more access distance vectors of one or more sets.

2. The method of claim 1, further comprising identifying at least the subset of the one or more sets and at least the subset of the one or more ways to be included in the set associative cache by comparing the values of the elements of the one or more access distance vectors to respective threshold values, the threshold values based on performance expectations for the cache design.

3. The method of claim 2 comprising forming an access distance stack comprising the elements of the one or more access distance vectors, with corresponding one or more sets disposed in a column direction and the one or more ways of each of the one or more sets disposed in the row direction, and selecting sets of the one or more sets and ways of the one or more ways having elements which meet the threshold values to be included in the cache design.

4. The method of claim 2, further comprising turning off or powering down sets of the one or more sets and ways of the one or more ways having elements which do not meet the threshold values, to conserve power.

5. The method of claim 1, further comprising determining a number of cache misses corresponding to the elements of the one or more access distance vectors and identifying at least the subset of the one or more sets and at least the subset of the one or more ways to be included in the set associative cache, further based on the cache misses corresponding to the elements of the one or more access distance vectors.

6. The method of claim 1, further comprising identifying the number of access distance instances encountered in the memory trace for the one or more ways within each of the one or more sets, based on mapping at least a subset of bits of an access address in the memory trace to the one or more sets.

7. A non-transitory computer-readable storage medium comprising code, which, when executed by a processor, causes the processor to perform a method of cache design, the non-transitory computer-readable storage medium comprising:
code for determining, for one or more sets of a set associative cache, a number of access distance instances encountered in a memory trace for one or more ways within each of the one or more sets, wherein an access distance instance for a way corresponds to a number of unique accesses to other ways which occur between two accesses for the same way;
code for forming an access distance vector for each of the one or more sets, wherein elements of the access distance vector for a set of the one or more sets comprise the number of access distance instances for each of the one or more ways of the set; and
code for identifying at least a subset of the one or more sets and at least a subset of the one or more ways to be included in a cache design of the set associative cache, based on the values of the elements of one or more access distance vectors of one or more sets.

8. The non-transitory computer-readable storage medium of claim 7, further comprising code for identifying at least the subset of the one or more sets and at least the subset of the one or more ways to be included in the set associative cache by comparing the values of the elements of the one or more access distance vectors to respective threshold values, the threshold values based on performance expectations for the cache design.

9. The non-transitory computer-readable storage medium of claim 8, comprising code for forming an access distance stack comprising the elements of the one or more access distance vectors, with corresponding one or more sets disposed in a column direction and the one or more ways of each of the one or more sets disposed in the row direction, and selecting sets of the one or more sets and ways of the one or more ways having elements which meet the threshold values to be included in the cache design.

10. The non-transitory computer-readable storage medium of claim 8, further comprising code for turning off or powering down sets of the one or more sets and ways of the one or more ways having elements which do not meet the threshold values, to conserve power.

11. The non-transitory computer-readable storage medium of claim 7, further comprising code for determining a number of cache misses corresponding to the elements of the one or more access distance vectors and identifying at least the subset of the one or more sets and at least the subset of the one or more ways to be included in the set associative cache, further based on the cache misses corresponding to the elements of the one or more access distance vectors.

12. The non-transitory computer-readable storage medium of claim 7, further comprising code for identifying the number of access distance instances encountered in the memory trace for the one or more ways within each of the one or more sets, based on mapping at least a subset of bits of an access address in the memory trace to the one or more sets.

13. An apparatus comprising:
a cache, wherein the cache is a set associative cache designed with at least a subset of one or more sets and at least a subset of one or more ways, wherein the subset of the one or more sets and the subset of the one or more ways are identified based on values of elements of one or more access distance vectors associated with the one or more sets, wherein the access distance vectors are determined based on:
for the one or more sets, a number of access distance instances encountered in a memory trace for one or more ways within each of the one or more sets, wherein an access distance instance for a way corresponds to a number of unique accesses to other ways which occur between two accesses for the same way, and
wherein elements of the access distance vector for a set belonging to the one or more sets comprise the number of access distance instances for each of the one or more ways of the set.

14. The apparatus of claim 13, wherein at least the subset of the one or more sets and at least the subset of the one or more ways to be included in the set associative cache is identified further based on a comparison of the values of the elements of the one or more access distance vectors to respective threshold values, the threshold values based on performance expectations for the design of the cache.

15. The apparatus of claim 14, wherein at least the subset of the one or more sets and at least the subset of the one or more ways to be included in the set associative cache is identified further based on an access distance stack, wherein the access distance stack comprises the elements of the one or more access distance vectors, with corresponding one or more sets disposed in a column direction and the one or more ways of each of the one or more sets disposed in the row direction, and wherein at least the subset of the one or more sets and at least the subset of the one or more ways to be included in the set associative cache have elements which meet the threshold values.

16. The apparatus of claim 14, further comprising logic to turn off or power down sets of the one or more sets and ways of the one or more ways having elements which do not meet the threshold values, to conserve power.

17. The apparatus of claim 13, further comprising logic configured to determine a number of cache misses corresponding to the elements of the one or more access distance vectors, wherein at least the subset of the one or more sets and at least the subset of the one or more ways to be included in the set associative cache are identified further based on the cache misses corresponding to the elements of the one or more access distance vectors.

18. The apparatus of claim 13, wherein the number of access distance instances encountered in the memory trace for the one or more ways within each of the one or more sets is identified further based on a mapping of at least a subset of bits of an access address in the memory trace to the one or more sets.

19. The apparatus of claim 13, integrated into a device selected from the group consisting of a set top box, a music player, a video player, an entertainment unit, a navigation device, a personal digital assistant (PDA), a fixed location data unit, a server, a computer, a laptop, a tablet, a communications device, and a mobile phone.

20. A method of cache design comprising:
step for determining, for one or more sets of a set associative cache, a number of access distance instances encountered in a memory trace for one or more ways within each of the one or more sets, wherein an access distance instance for a way corresponds to a number of unique accesses to other ways which occur between two accesses for the same way;
step for forming an access distance vector for each of the one or more sets, wherein elements of the access distance vector for a set belonging to the one or more sets comprise the number of access distance instances for each of the one or more ways of the set; and
step for identifying at least a subset of the one or more sets and at least a subset of the one or more ways to be included in a cache design of the set associative cache, based on the values of the elements of one or more access distance vectors of one or more sets.

21. The method of claim 20, further comprising step for identifying at least the subset of the one or more sets and at least the subset of the one or more ways to be included in the set associative cache based on step for comparing the values of the elements of the one or more access distance vectors to respective threshold values, the threshold values based on performance expectations for the cache design.

22. The method of claim 21, comprising step for forming an access distance stack comprising the elements of the one or more access distance vectors, with corresponding one or more sets disposed in a column direction and the one or more ways of each of the one or more sets disposed in the row direction, and selecting sets of the one or more sets and ways of the one or more ways having elements which meet the threshold values to be included in the cache design.

23. The method of claim 21, further comprising step for turning off or powering down sets of the one or more sets and ways of the one or more ways having elements which do not meet the threshold values, to conserve power.

24. The method of claim 20, further comprising step for determining a number of cache misses corresponding to the elements of the one or more access distance vectors and identifying at least the subset of the one or more sets and at least the subset of the one or more ways to be included in the set associative cache, further based on the cache misses corresponding to the elements of the one or more access distance vectors.

25. The method of claim 20, further comprising step for identifying the number of access distance instances encountered in the memory trace for the one or more ways within each of the one or more sets, based on mapping at least a subset of bits of an access address in the memory trace to the one or more sets.
